(19) United States
(12) Patent Application Publication
(10) Pub. No.: US 2019/0031877 A1
(43) Pub. Date: Jan. 31, 2019

(54) POLYCARBONATE COMPOSITIONS WITH IMPROVED RESISTANCE TO HYDROLYSIS

(71) Applicant: Covestro AG, Leverkusen (DE)

(72) Inventors: Thomas Eckel, Dormagen (DE); Kristina Pupovac, Düsseldorf (DE)

(21) Appl. No.: 16/072,077

(22) PCT Filed: Mar. 22, 2017
(86) PCT No.: PCT/EP2017/056870

§ 371 Date: Jul. 23, 2018

(30) Foreign Application Priority Data
Mar. 23, 2016 (EP) 16161898.8

(51) Int. Cl. C08L 69/00; C09K 21/12

(52) U.S. Cl. CPC C08L 69/00; C09K 21/12; C08L 2201/08; C08L 2205/035; C08L 2201/02; C08L 2205/03

(57) ABSTRACT

The invention relates to compositions containing A) 62 to 96 wt. % of at least one polymer selected from the group consisting of linear aromatic polycarbonate and linear aromatic polyester carbonate, B) 1 to 15 wt. % of at least one graft polymer produced by emulsion polymerization C) 0 to 5.8 wt. % of a rubber-free vinyl (co)polymer, D) 1 to 20 wt. % of at least one phosphorous-containing flame retardant, E) 0.8 to 4.0 wt. % of a mineral filler based on talc with a particle size d₅₀ of 0.2 to 10 μm, and F) 0.1 to 20.0 wt. % of at least one polymer additive, wherein the compositions do not contain a graft polymer produced in a bulk polymerization process. The invention also relates the use of the compositions in order to produce molded bodies and to the molded bodies themselves.

The present invention relates to flame-retardant polycarbonate compositions comprising small quantities of talc, to the use of the compositions for the production of mouldings, and to the mouldings themselves.

Compositions made of polycarbonate and of ABS polymers have a long history. In numerous Patent Applications it has moreover been said that such compositions can be rendered flame-retardant by using oligophosphates, and moreover can comprise fillers.

US 2009/0215949 A1 discloses moulding compositions made of polycarbonate and ABS produced by bulk polymerization and/or MBS, where these have been rendered flame-retardant by using bisphenol-A-based oligophosphate and comprise inorganic fillers such as kaolin, talc and aluminium oxide. It is said that addition of fillers improves the flame retardancy properties.

EP 1 026 205 A1 describes polymer mixtures made of aromatic polycarbonate, of ABS graft polymer and/or of styrene-containing copolymer, where these comprise by way of example kaolin, talc, mica, wollastonites, glass fibre and mixtures thereof as inorganic fillers and feature excellent hydrolysis resistance and flame retardancy. Triphenyl phosphate and resorcinol bis(dixylenyl) phosphate are used as flame retardant. There is no mention of use of bisphenol A bis(diphenyl phosphate) as flame retardant.

EP 1 164 168 A1 discloses impact-modified PC moulding compositions with hydrolysis resistance improved by addition of a talc at a concentration of from 0.1 to 5% and with average particle diameter from 0.1 to 50 μm. The polymer mixtures have flame retardancy due to use of triphenyl phosphate as flame retardant.

WO 2012/106392 A1 discloses polycarbonate compositions comprising ABS and resorcinol diphosphate as flame retardant and talc as filler. The polymer mixtures feature good flame retardancy and reduced halogen content, and good mechanical properties.

WO 01/48074 A1 discloses flame-retardant PC/ABS compositions with excellent flame retardancy, good chemicals resistance and low mould abrasion and which cause very little deposit formation, comprising from 40 to 98 parts by weight of polycarbonate, from 0.5 to 50 parts by weight of graft polymer, from 0.5 to 40 parts by weight of phosphorus-containing flame retardant and from 0.05 to 40 parts by weight of a specific high-purity talc.

WO 01/66635 A1 describes polycarbonate compositions with low fluorine content, equipped with a bisphenol-A-based oligophosphate as flame retardant and comprising from 0 to 5 parts by weight of a fine inorganic material in the form of particles, flakes or fibres, preferably talc; the compositions feature excellent flame retardancy and good chemicals resistance and good heat resistance.

WO 02/059203 A1 describes flame-retardant PC/ABS compositions comprising talc and phosphoric ester, using talc grades having different iron content. It is disclosed that the moulding compositions comprising talc grades with relatively low iron content have improved notched impact resistance.

WO 2009/080246 A1 discloses flame-retardant polycarbonate compositions in which a combination of a talc and a phosphinic salt as flame retardant achieves improved flame retardancy, heat resistance, improved ESC behaviour and relatively high modulus of elasticity and relatively high hydrolysis resistance. However, tensile strain at break and weld line strength are at a low level in compositions of the type revealed in that disclosure.

WO 2009/040772 A1 discloses compositions comprising polycarbonate, polysiloxane-polycarbonate copolymer, impact modifier and filler with d₅₀ particle size less than 2.7 μm. The compositions feature good flame retardancy, flexural modulus and impact resistance, and good surface quality.

However, the abovementioned compositions are not suitable for components with complex geometries and thin walls, where particular requirements are placed upon the mechanical properties. The expression mechanical properties for applications of these types means an advantageous combination of high tensile modulus of elasticity, high weld line strength and high tensile strain at break.

None of the documents mentioned moreover describes hydrolysis-resistant polycarbonate compositions which have the required mechanical properties.

It was therefore desirable to provide polycarbonate compositions which feature good mechanical properties, good chemicals resistance and good flame retardancy together with good hydrolysis resistance.

It was moreover desirable to provide polycarbonate compositions which feature good weld line strength and high tensile strain at break, high tensile modulus of elasticity, good chemicals resistance with respect to a toluene/isopropanol mixture and good flame retardancy (classification and afterflame time) for a component of thickness 1.5 mm, together with good hydrolysis resistance.

Surprisingly, it has now been found that compositions comprising

A) from 62 to 96% by weight, preferably from 64 to 95% by weight, particularly preferably from 66 to 94% by weight, of at least one polymer selected from the group consisting of linear aromatic polycarbonate and linear aromatic polyester carbonate,

B) from 1 to 15% by weight, preferably from 2 to 12% by weight, particularly preferably from 3 to 10% by weight, of at least one graft polymer produced by emulsion polymerization from
B.1) from 5 to 95% by weight, based on B, of a mixture of
   B.1.1) from 50 to 99% by weight, based on B.1, of at least one monomer selected from the group of the vinylaromatics, ring-substituted vinylaromatics and C1-C8-alkyl acrylates and mixtures of these compounds
and
   B.1.2) from 1 to 50% by weight, based on B.1, of at least one monomer selected from the group of the vinyl cyanides, C1-C8-alkyl acrylates, unsaturated carboxylic acids and derivatives of unsaturated carboxylic acids
B.2) from 5 to 95% by weight, based on B, of a rubber-containing graft base comprising a diene rubber or comprising a copolymer of a diene rubber with another copolymerizable monomer,

C) from 0 to 5.8% by weight, preferably from 0 to 5.5% by weight, particularly preferably from 0 to 5.2% by weight, of rubber-free vinyl (co)polymer,

D) from 1 to 20% by weight, preferably from 1 to 19% by weight, particularly preferably from 2 to 18% by weight, of at least one phosphorus-containing flame retardant of the general formula (IV)

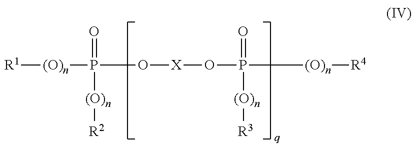

in which
R1, R2, R3 and R4, mutually independently respectively denote optionally halogenated C1 to C8-alkyl, respectively optionally alkyl-substituted, preferably C1- to C4-alkyl-substituted, and/or halogen-substituted, preferably chlorine- or bromine-substituted, C5 to C6-cycloalkyl, C6 to C20-aryl or C7 to C12-aralkyl,
n mutually independently denotes 0 or 1, preferably being equal to 1,
q represents integral values from 1 to 30, preferably from 1 to 20, particularly preferably from 1 to 10, or in the case of mixtures represents average values from 1.01 to 5.0, preferably from 1.02 to 3.0, more preferably from 1.05 to 2.00, and particularly preferably from 1.08 to 1.60,
X denotes a polynuclear aromatic moiety having from 13 to 30 C atoms which can optionally have substituent halogen groups and/or substituent alkyl groups, preferably chlorine, bromine and/or C1 to C4-alkyl substituents,

E) from 0.8 to 4.0% by weight, preferably from 0.9 to 3.5% by weight, particularly preferably from 1.0 to 3.0% by weight, of a mineral filler based on talc with d₅₀ particle size from 0.2 to 10 μm and preferably from 28 to 35% by weight MgO content, based on component E,

F) from 0.1 to 20.0% by weight, preferably from 0.2 to 15% by weight, particularly preferably from 0.3 to 10% by weight, of at least one polymer additive,

where the compositions comprise no graft polymer produced by bulk polymerization,

have the advantageous properties.

Further embodiments 1 to 17 of the present invention are described below:

1. Compositions comprising

A) from 62 to 96% by weight of at least one polymer selected from the group consisting of linear aromatic polycarbonate and linear aromatic polyester carbonate,

B) from 1 to 15% by weight of at least one graft polymer produced by emulsion polymerization from
B.1) from 5 to 95% by weight, based on B, of a mixture of
   B.1.1) from 50 to 99% by weight, based on B.1, of at least one monomer selected from the group of the vinylaromatics, ring-substituted vinylaromatics and C1-C8-alkyl acrylates and mixtures of these compounds
and
   B.1.2) from 1 to 50% by weight, based on B.1, of at least one monomer selected from the group of the vinyl cyanides, C1-C8-alkyl acrylates, unsaturated carboxylic acids and derivatives of unsaturated carboxylic acids
B.2) from 5 to 95% by weight, based on B, of a rubber-containing graft base comprising a diene rubber or comprising a copolymer of a diene rubber with another copolymerizable monomer,

C) from 0 to 5.8% by weight of rubber-free vinyl (co)polymer,

D) from 1 to 20% by weight of at least one phosphorus-containing flame retardant of the general formula (IV)

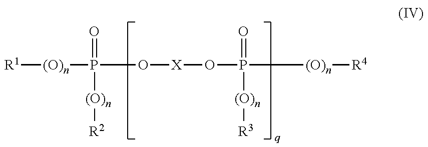

in which
R1, R2, R3 and R4, mutually independently respectively denote optionally halogenated C1 to C8-alkyl, respectively optionally alkyl-substituted C5 to C6-cycloalkyl, C6 to C20-aryl or C7 to C12-aralkyl,
n mutually independently denotes 0 or 1
q denotes integral values from 1 to 30
X denotes a polynuclear aromatic moiety having from 13 to 30 C atoms which can optionally have substituent halogen groups and/or substituent alkyl groups,

E) from 0.8 to 4.0% by weight of a mineral filler based on talc with d₅₀ particle size from 0.2 to 10 μm,

F) from 0.1 to 20.0% by weight of at least one polymer additive, where the compositions comprise no graft polymer produced by bulk polymerization.

2. Compositions according to embodiment 1 comprising

from 64 to 95% by weight of component A,

from 2 to 12% by weight of component B,

from 0 to 5.5% by weight of component C,

from 1 to 19% by weight of component D,

from 0.9 to 3.5% by weight of component E and

from 0.2 to 15% by weight of component F.

3. Compositions according to embodiment 1 comprising

from 66 to 94% by weight of component A,

from 3 to 10% by weight of component B,

from 0 to 5.2% by weight of component C,

from 2 to 18% by weight of component D,

from 1.0 to 3.0% by weight of component E and

from 0.3 to 10% by weight of component F.

4. Compositions according to any of the preceding embodiments where the weight-average molar mass Mw of component A is from 24 000 to 28 000 g/mol.

5. Compositions according to any of the preceding embodiments where component B is composed of

from 40 to 70% by weight of B.1 and from 60 to 30% by weight of B.2, based in each case on B.

6. Compositions according to any of the preceding embodiments where styrene is used as component B1.1 and acrylonitrile is used as component B1.2.

7. Compositions according to any of the preceding embodiments where component D is a compound according to the following structure

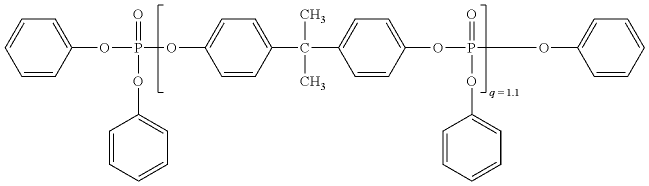

8. Compositions according to any of the preceding embodiments where a mineral filler with at least 98% by weight talc content is used as component E.

9. Compositions according to any of the preceding embodiments where component E is talc with from 28 to 35% by weight MgO content, from 55 to 65% by weight SiO₂ content and less than 1% by weight Al₂O₃ content.

10. Compositions according to any of the preceding embodiments where the d₅₀ particle size of component E is from 0.7 to 2.5 μm.

11. Compositions according to any of the preceding embodiments where the MgO content of component E is from 30.5 to 32% by weight.

12. Compositions according to any of the preceding embodiments where component F used comprises one or more additives from the group consisting of flame retardant synergists, antidripping agent, lubricant and mould-release agent, flowability aid, antistatic agents, conductivity additives, stabilizers, antibacterial additives, additives that improve scratch resistance, IR absorbers, optical brightener, fluorescent additives, dyes, pigments and Brönstedt acid compounds.

13. Compositions according to any of the preceding embodiments where the compositions are composed only of components A to F.

14. Use of talc with d₅₀ particle size from 0.7 to 2.5 μm and from 28 to 35% by weight MgO content to improve the hydrolysis resistance of polycarbonate compositions comprising a graft polymer produced by the emulsion process and bisphenol A oligophosphate as flame retardant.

15. Use according to embodiment 14 where the graft polymer is composed of a graft base made of diene rubber and of a graft made of styrene-acrylonitrile copolymer.

16. Use of compositions according to any of the embodiments 1 to 13 for the production of mouldings.

17. Mouldings obtainable from compositions according to any of embodiments 1 to 13.

Component A

Linear aromatic polycarbonates and linear polyester carbonates according to component A that are suitable according to the invention are known to the literature or can be produced by processes known from the literature; (for the production of aromatic polycarbonates see by way of example Schnell, “Chemistry and Physics of Polycarbonates”, Interscience Publishers, 1964 and German Auslegeschrift 1 495 626, DE-A 2 232 877, DE-A 2 703 376, DE-A 2 714 544, DE-A 3 000 610, DE-A 3 832 396; for the production of aromatic polyester carbonates see by way of example DE-A 3 077 934). Aromatic polycarbonates and polyester carbonates are produced by way of example via a reaction of diphenols with carbonyl halides, preferably phosgene, and/or with aromatic diacyl dihalides, preferably dihalides of benzenedicarboxylic acids, by the interfacial process, optionally with use of chain terminators, for example monophenols. Another possibility is production by way of a melt polymerization process via reaction of diphenols with, for example, diphenyl carbonate.

Diphenols for the production of the aromatic polycarbonates and/or aromatic polyester carbonates are preferably those of the formula (I)

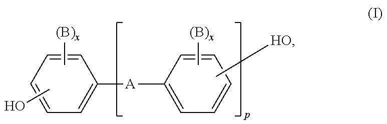

where
A is a single bond, C₁ to C₅-alkylene, C₂, to C₅-alkylidene, C₅ to C₆-cycloalkylidene, —SO—, —CO—, —S—, —SO₂—, C₆ to C₁₂-arylene, onto which further aromatic rings optionally comprising heteroatoms can have been condensed,
   or a moiety of the formula (II) or (III)

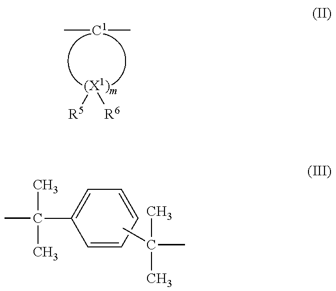

B is respectively C, to C, preferably methyl, or halogen, preferably chlorine and/or bromine,
x is respectively mutually independently 0, 1 or 2,
p is 1 or 0, and
R⁵ and R⁶ can be selected individually for each X¹, being mutually independently hydrogen or C₁ to C₆-alkyl, preferably hydrogen, methyl or ethyl,
X¹ denotes carbon and
m denotes an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis(hydroxyphenyl)-C₁-C₅, alkanes, bis(hydroxyphenyl)-C₅-C₆-bis(hydroxyphenyl) ethers, bis(hydroxyphenyl) sulphoxides, bis(hydroxyphenyl) ketones, bis(hydroxyphenyl) sulphones and α,α-bis(hydroxyphenyl)diisopropylbenzenes, and also ring-brominated and/or ring-chlorinated derivatives of these.

Particularly preferred diphenols are 4,4′-dihydroxybiphenyl, bisphenol-A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxybiphenyl sulphide, 4,4′-dihydroxybiphenyl sulphone, and also the di- and tetrabrominated or chlorinated derivatives of these, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-bis(4-hydroxyphenyl)propane (bisphenol A) is in particular preferred.

The diphenols may be used individually or in the form of any desired mixtures. The diphenols are known from the literature or obtainable by processes known from the literature.

Examples of suitable chain terminators for the production of the thermoplastic, aromatic polycarbonates are phenol, p-chlorophenol, p-tert-butylphenol and 2,4,6-tribromophenol, and also long-chain alkylphenols, for example 4-[2-(2,4,4-trimethylpentyl)]phenol, 4-(1,3-tetramethylbutyl)phenol according to DE-A 2 842 005 and monoalkylphenols and dialkylphenols having a total of from 8 to 20 carbon atoms in the alkyl substituents, for example 3,5-di-tert-butylphenol, p-isooctylphenol, p-tertoctylphenol, p-dodecylphenol and 2-(3,5-dimethylheptyl)phenol and 4-(3,5-dimethylheptyl)phenol. The quantity of chain terminators to be used is generally from 0.5 mol % to 10 mol %, based on the total molar quantity of the respective diphenols used.

Homopolycarbonates and copolycarbonates are suitable.

Preferred polycarbonates, alongside the bisphenol A homopolycarbonates, are the copolycarbonates of bisphenol A with up to 15 mol %, based on the total molar quantities of diphenols, of other diphenols mentioned as preferred or particularly preferred, in particular 2,2-bis(3,5-dibromo-4-hydroxyphenyl)propane.

Aromatic diacyl dihalides for the production of aromatic polyester carbonates are preferably the diacyl dichlorides of isophthalic acid, of terephthalic acid, of diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio of from 1:20 to 20:1.

Production of polyester carbonates additionally makes concomitant use of a carbonyl halide, preferably phosgene, as bifunctional acid derivative.

Chain terminators that can be used for the production of the aromatic polyester carbonates are not only the abovementioned monophenols but also the chlorocarbonic esters of these, and also the acyl chlorides of aromatic monocarboxylic acids, which can optionally have substitution by C₁ to C₂₂-alkyl groups or by halogen atoms; aliphatic C₂ to C₂₂-monoacyl chlorides can also be used as chain terminators here.

The quantity of chain terminators in each case is from 0.1 to 10 mol %, based on moles of diphenol in the case of the phenolic chain terminators and on moles of diacyl dichloride in the case of monoacyl chloride chain terminators.

The aromatic polyester carbonates may also incorporate aromatic hydroxycarboxylic acids.

The proportion of carbonate structural units in the thermoplastic aromatic polyester carbonates can vary as desired. The proportion of carbonate groups is preferably up to 100 mol %, in particular up to 80 mol %, particularly preferably up to 50 mol %, based on the entirety of ester groups and carbonate groups. The ester fraction of the aromatic polyester carbonates, and also the carbonate fraction thereof, can take the form of blocks or can have random distribution in the polycondensate.

The relative solution viscosity (ηᵣₑₗ) of the aromatic polycarbonates and polyester carbonates is preferably in the range from 1.18 to 1.4, particularly preferably in the range from 1.20 to 1.32 (measured on solutions of 0.5 g of polycarbonate or polyester carbonate in 100 ml of methylene chloride at 25° C.). The weight-average molar mass Mw of the aromatic polycarbonates and polyester carbonates is preferably in the range from 15 000 to 35 000 g/mol, more preferably in the range from 20 000 to 33 000 g/mol, particularly preferably from 23 000 to 30 000 g/mol, particularly preferably from 24 000 to 28 000 g/mol determined via GPC (gel permeation chromatography in methylene chloride with polycarbonate as standard).

Component B

Materials that can be used according to the invention as component B are one or more graft polymers of
B.1) from 5 to 95% by weight, preferably from 30 to 80% by weight, particularly preferably from 40 to 70% by weight, of a mixture of
   B.1.1) from 50 to 99% by weight, preferably from 65 to 85% by weight, particularly preferably from 70 to 80% by weight, based on B.1, preferably of at least one monomer selected from the group of the vinylaromatics (for example styrene, α-methylstyrene), ring-substituted vinylaromatics (for example p-methylstyrene, p-chlorostyrene) and C1-C8-alkyl acrylates (for example n-butyl acrylate, tert-butyl acrylate) or a mixture of these compounds
   and
   B.1.2) from 1 to 50% by weight, preferably from 15 to 35% by weight, particularly preferably from 20 to 30% by weight, based on B.1, of at least one monomer selected from the group of the vinyl cyanides (for example unsaturated nitriles such as acrylonitrile and methacrylonitrile), C1-C8-alkyl acrylates (for example n-butyl acrylate, tert-butyl acrylate), unsaturated carboxylic acids and derivatives of unsaturated carboxylic acids (for example maleic anhydride and N-phenylmaleimide)
B.2) from 5 to 95% by weight, preferably from 20 to 70% by weight, particularly preferably from 30 to 60% by weight, of a rubber-containing graft base comprising a diene rubber or comprising a copolymer of a diene rubber with another copolymerizable monomer.

The glass transition temperatures of the graft bases B.2 are <10° C., preferably <0° C., particularly preferably <−20° C.

Unless expressly otherwise stated in the present invention, the glass transition temperature is determined for all components by means of dynamic scanning calorimetry (DSC) in accordance with DIN 53765, (1994 version) with heating rate 10 K/min, Tg being determined as midpoint temperature (tangent method).

The median particle size (d50 value) of the graft base B.2 is generally from 0.05 to 10.00 μm, preferably from 0.10 to 5.00 μm, more preferably from 0.15 to 1.00 μm, and particularly preferably from 0.2 to 0.7 μm.

The median particle size d50 is the diameter above and below which 50% by weight of the particles respectively lie. It can be determined by ultracentrifuge measurement (W. Scholtan, H. Lange, Kolloid, Z. and Z. Polymere 250 (1972), 782-1796).

The graft bases B.2 are diene rubbers, based for example on butadiene and isoprene, or a mixture of diene rubbers, or are copolymers of diene rubbers or of a mixture of these with other copolymerizable monomers (e.g. styrene or methyl methacrylate) or are EPDM rubbers (i.e. rubbers based on ethylene/propylene and diene), with the proviso that the glass transition temperature of component B.2 is <10° C., preferably <0° C., particularly preferably <−20° C.

Preference is given to polybutadiene rubber used alone. In another embodiment, B.2 is styrene-butadiene block copolymer rubber.

The gel content of the graft base B.2 is at least 30% by weight, preferably at least 40% by weight, particularly preferably at least 70% by weight (measured in toluene).

The gel content of the graft base B.2, and also of component B, is determined at 25° C. in a suitable solvent (M. Hoffmann, H. Krömer, R. Kuhn, Polymeranalytik I and II [Polymer analysis I and II], Georg Thieme-Verlag, Stuttgart 1977).

Graft polymers according to component B are ABS polymers as described by way of example in Ullmanns Enzyklopädie der Technischen Chemie [Ullmann's Encyclopaedia of Industrial Chemistry], Vol. 19 (1980), pp. 280 ff., produced by the emulsion polymerization process.

It is preferable that the graft polymer of components B.1 and B.2 has a core-shell structure where component B.1 forms the shell and component B.2 forms the core; (see by way of example Ullmann's

Encyclopedia of Industrial Chemistry, VCH-Verlag, Vol. A21, 1992, p. 635 and p. 656).

Other particularly suitable graft rubbers are ABS polymers which are produced by the emulsion polymerization process via redox initiation using an initiator system made of organic hydroperoxide and ascorbic acid according to U.S. Pat. No. 4,937,285.

It is known that the graft monomers are not necessarily entirely grafted onto the graft base during the graft reaction, and therefore according to the invention the definition of rubber-modified graft polymers according to component B includes products which are obtained via (co)polymerization of the graft monomers B.1 in the presence of the graft base B.2 and which are concomitant products arising during work-up.

Component C

The composition can comprise, as further component C, (co)polymers of at least one monomer from the group of the vinylaromatics, vinyl cyanides (unsaturated nitriles), C1 to C8-alkyl (meth)acrylates, unsaturated carboxylic acids and derivatives (such as anhydrides and imides) of unsaturated carboxylic acids.

Materials in particular suitable as component C are (co)polymers of

C.1 from 50 to 99% by weight, preferably from 65 to 85% by weight, particularly preferably from 70 to 80% by weight, based on the (co)polymer C, of at least one monomer selected from the group of the vinylaromatics (for example styrene, α-methylstyrene), ring-substituted vinylaromatics (for example p-methylstyrene, p-chlorostyrene) and C1-C8-alkyl (meth)acrylates (for example methyl methacrylate, n-butyl acrylate, tert-butyl acrylate) and

C.2 from 1 to 50% by weight, preferably from 15 to 35% by weight, particularly preferably from 20 to 30% by weight, based on the (co)polymer C, of at least one monomer selected from the group of the vinyl cyanides (for example unsaturated nitriles such as acrylonitrile and methacrylonitrile), C1-C8-alkyl (meth)acrylates (for example methyl methacrylate, n-butyl acrylate, tert-butyl acrylate), unsaturated carboxylic acids and derivatives of unsaturated carboxylic acids (for example maleic anhydride and N-phenylmaleimide).

These (co)polymers C are resinous, thermoplastic and rubber-free. Particular preference is given to the copolymer of C.1 styrene and C.2 acrylonitrile.

(Co)polymers C of this type are known and can be produced via free-radical polymerization, in particular via emulsion polymerization, suspension polymerization, solution polymerization or bulk polymerization. The weight-average molar mass (Mw) of the (co)polymers C, determined by gel permeation chromatography (GPC) in tetrahydrofuran with polystyrene as standard, is preferably from 50 000 to 200 000 g/mol, particularly preferably from 70 000 to 150 000 g/mol, particularly preferably from 80 000 to 120 000 g/mol.

Component D

Phosphorus-containing flame retardants D for the purposes of the invention are selected from the groups of the mono- and oligomeric phosphoric and phosphonic esters, and it is also possible here to use mixtures of a plurality of components as flame retardant.

Mono- and oligomeric phosphoric or phosphonic esters for the purposes of this invention are phosphorus compounds of the general formula (IV)

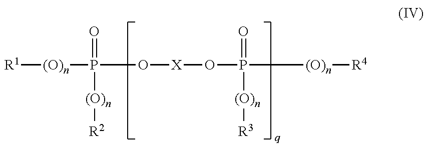

in which

R1, R2, R3 and R4, mutually independently respectively denote optionally halogenated C1 to C8-alkyl, respectively optionally alkyl-substituted, preferably C1- to C4-alkyl-substituted, and/or halogen-substituted, preferably chlorine- or bromine-substituted, C5 to C6-cycloalkyl, C6 to C20-aryl or C7 to C12-aralkyl,

n mutually independently denotes 0 or 1, preferably being equal to 1,

q represents integral values from 1 to 30, preferably from 1 to 20, particularly preferably from 1 to 10, or in the case of mixtures represents average values from 1.01 to 5.0, preferably from 1.02 to 3.0, more preferably from 1.05 to 2.00, and particularly preferably from 1.08 to 1.60,

X denotes a polynuclear aromatic moiety having from 13 to 30 C atoms which can optionally have substituent halogen groups and/or substituent alkyl groups, preferably chlorine, bromine and/or C1 to C4-alkyl substituents.

It is preferable that R1, R2, R3 and R4 mutually independently represent C1 to C4-alkyl, phenyl, naphthyl or phenyl-C1-C4-alkyl. The aromatic groups R1, R2, R3 and R4 can themselves have substitution by halogen groups and/or by alkyl groups, preferably chlorine, bromine and/or C1 to C4-alkyl. Particularly preferred aryl moieties are cresyl, phenyl, xylenyl, propylphenyl and butylphenyl, and also the corresponding brominated and chlorinated derivatives thereof.

X particularly preferably represents

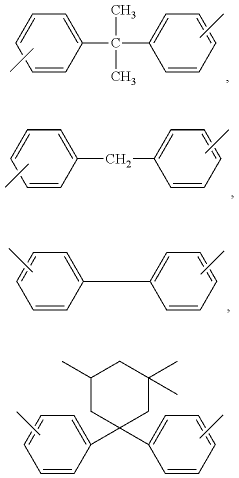

or chlorinated or brominated derivatives of these; in particular, X derives from bisphenol A or from diphenylphenol. It is particularly preferable that X derives from bisphenol A.

Bisphenol-A-based oligophosphate according to formula (IVa) is most preferred as component D.

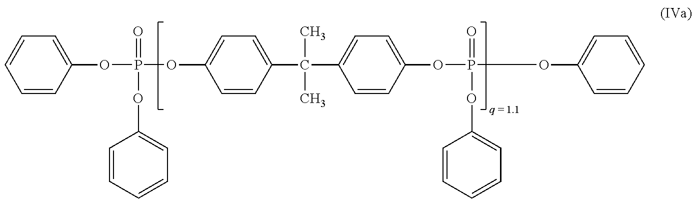

The phosphorus compounds according to component D are known (cf. for example EP-A 0 363 608, EP-A 0 640 655) or can be produced by known methods in analogous manner (cf. for example Ullmanns Enzyklopädie der technischen Chemie [Ullmann's Encyclopaedia of Industrial Chemistry], Vol. 18, pp. 301 ff. 1979; Houben-Weyl, Methoden der organischen Chemie [Methods of organic chemistry], Vol. 12/1, p. 43; Beilstein Vol. 6, p. 177).

Other materials that can be used as component D of the invention are mixtures of phosphates with different chemical structure and/or with identical chemical structure and different molecular weight. It is preferable to use mixtures having identical structure and different chain length, and in this case the stated q value is the average q value. The average q value is determined by using high pressure liquid chromatography (HPLC) at 40° C. in a mixture of acetonitrile and water (50:50) to determine the composition of the phosphorus compound (molecular weight distribution) and using this to calculate the average values for q.

Component E

The thermoplastic moulding compositions comprise, as component E, a mineral filler based on talc.

For the purposes of the invention, mineral fillers that can be used, based on talc, are any of the particulate fillers that the person skilled in the art associates with talc or with talc powder. Likewise, all particulate fillers which are commercially available and whose product descriptions contain the terms talc or talcum as characterizing features are possible.

Mixtures of various mineral fillers based on talc can also be used.

Mineral fillers according to the invention have more than 80% by weight, preferably more than 95% by weight and particularly preferably more than 98% by weight talc content in accordance with DIN 55920 (2006 version), based on the total composition of filler.

Talc is defined as a naturally occurring or synthetically produced talc.

Pure talc is a silicate with layer structure.

The talc grades used as component E feature particularly high purity, characterized by from 28 to 35% by weight MgO content, preferably from 30 to 33% by weight, particularly preferably from 30.5 to 32% by weight, and from 55 to 65% by weight SiO₂ content, preferably from 58 to 64% by weight, particularly preferably from 60 to 62.5% by weight. The particularly preferred talc grades moreover feature less than 5% by weight Al₂O₃ content, particularly preferably less than 1% by weight, in particular less than 0.7% by weight.

It is also advantageous, and to that extent preferred, to use the talc of the invention in the form of finely ground grades with d₅₀ median particle size from 0.2 to 10 μm, preferably from 0.5 to 5 μm, more preferably from 0.7 to 2.5 μm, and particularly preferably from 1.0 to 2.0 μm.

The median particle size d₅₀ is the diameter above and below which 50% by weight of the particles respectively lie. It is also possible to use mixtures of talc grades which differ in their d₅₀ median particle size.

The talc grades to be used according to the invention preferably have an upper particle size or upper grain size d₉₇ below 50 μm, preferably below 10 μm, particularly preferably below 6 μm and with particular preference below 2.5 μm. The d₉₇ and d₅₀ values of the talc are determined by sedimentation analysis, using a Sedigraph 5100 (Micromeritics GmbH, Erftstrasse 43, 41238 Mönchengladbach, Germany) in accordance with ISO 13317-1 and ISO 13317-3 (2000 version).

The talc can have been surface-treated, e.g. silanized, in order to ensure better compatibility with the polymer. The talc can by way of example have been equipped with a coupling agent system based on functionalized silanes.

In respect of the processing and production of the moulding compositions it is also advantageous to use compacted talc.

As a result of the processing to give the moulding composition or to give mouldings, the d₉₇ and/or d₅₀ value of the talc used can be smaller in the moulding composition and/or in the moulding than in the starting material.

Component F

The composition comprises, as component F, commercially available polymer additives different from components D and E. Commercially available polymer additives according to component F that can be used are additives such as flame retardant synergists, antidripping agents (for example compounds of the substance classes of the fluorinated polyolefins, the silicones, and also aramid fibres), internal and external lubricants and internal and external mould-release agents (for example pentaerythritol tetrastearate, stearyl stearate, montan wax or polyethylene wax), flowability aids, antistatic agents, (for example block copolymers of ethylene oxide and propylene oxide, other polyethers or polyhydroxyethers, polyetheramides, polyesteramides or sulphonic salts), conductivity additives (for example conductive carbon black or carbon nanotubes), stabilizers (for example UV/light stabilizers, heat stabilizers, antioxidants, hydrolysis stabilizers), antibacterial additives (for example silver or silver salts), additives that improve scratch resistance (for example silicone oils or hard fillers such as ceramic (hollow) spheres), IR absorbers, optical brighteners, fluorescent additives, and also dyes and pigments (for example carbon black, titanium dioxide or iron oxide), and Brönstedt acid compounds as base scavengers, or else a mixture of a plurality of the additives mentioned.

In particular, polytetrafluoroethylene (PTFE) or a PTFE-containing composition is used as antidripping agent, an example being a masterbatch of PTFE with styrene or methyl-methacrylate-containing polymers or copolymers, in the form of powder or of coagulated mixture, e.g. with component B. The fluorinated polyolefins used as antidripping agents have high molecular weight and have glass transition temperatures above −30° C., generally above 100° C., fluorine contents that are preferably from 65 to 76% by weight, in particular from 70% to 76% by weight, and d₅₀ median particle diameters from 0.05 to 1000 μm, preferably from 0.08 to 20 μm. The density of the fluorinated polyolefins is generally from 1.2 to 2.3 g/cm³. Preferred fluorinated polyolefins are polytetrafluoroethylene, polyvinylidene fluoride, tetrafluoroethylene/hexafluoropropylene copolymers and ethylene/tetrafluoroethylene copolymers. The fluorinated polyolefins are known (cf. “Vinyl and Related Polymers” by Schildknecht, John Wiley & Sons, Inc., New York, 1962, pp. 484-494; “Fluoropolymers” by Wall, Wiley-Interscience, John Wiley & Sons, Inc., New York, Vol. 13, 1970, pp. 623-654; “Modern Plastics Encyclopedia”, 1970-1971, Vol. 47, No. 10 A, October 1970, McGraw-Hill, Inc., New York, pp. 134 and 774; “Modern Plastics Encyclopedia”, 1975-1976, October 1975, Vol. 52, No. 10 A, McGraw-Hill, Inc., New York, pp. 27, 28 and 472 and U.S. Pat. Nos. 3,671,487, 3,723,373 and 3,838,092).

Suitable fluorinated polyolefins D that can be used in powder form are tetrafluoroethylene polymers with median particle diameter from 100 to 1000 μm and densities from 2.0 g/cm³ to 2.3 g/cm³. Suitable tetrafluoroethylene polymer powders are commercially available products and are supplied by way of example by DuPont with trademark Teflon®.

The compositions of the invention particularly preferably comprise at least one mould-release agent, preferably proportions by weight of from 0.1 to 1.0% of pentaerythritol tetrastearate, based on the entirety of components A to E, and particularly preferably comprise at least one stabilizer, preferably a phenolic antioxidant, particularly preferably proportions by weight of from 0.01 to 1.0% of 2,6-di-tert-butyl-4-(octadecanoxycarbonylethyl)phenol, based on the entirety of components A to F.

The compositions of the invention comprising components A to F and optionally other components can be used to produce moulding compositions. For this, the components are mixed in a known manner and are compounded, at temperatures of from 200° C. to 330° C., in a melt or extruded in a melt in conventional assemblies such as internal mixers, extruders and twin-screw machines. Mouldings can be produced from the moulding compositions in a further processing step.

The compositions of the present invention can be used for the production of mouldings of any type. In particular, mouldings can be produced via injection moulding. Examples of mouldings that can be produced are: Housing parts of any type, for example for household devices, for example TV devices and HiFi devices, coffee machines, mixers, office equipment, for example monitors and printers, and protective covering sheets for the construction sector and parts for the motor vehicle sector.

The compositions are particularly suitable for the production of thin-walled housing parts in the electrical and the electronics sector.

Another form of processing is production of mouldings via blowmoulding or via thermoforming from previously produced sheets or films.

### EXAMPLES

Component A-1:

Linear polycarbonate based on bisphenol A with weight-average molar mass M_{w} 25 000 g/mol (determined by GPC in methylene chloride, using polycarbonate as standard).

Component A-2:

Linear polycarbonate based on bisphenol A with weight-average molar mass M_{w} 32 000 g/mol (determined by GPC in methylene chloride, using polycarbonate as standard).

Component A-3:

Branched polycarbonate based on bisphenol A with weight-average molar mass M_{w} 32 000 g/mol (determined by GPC in methylene chloride, using polycarbonate as standard).

Component B:

Graft polymer of 45 parts by weight of a copolymer of styrene and acrylonitrile in a ratio of 72:28 on 55 parts by weight of a particulate crosslinked polybutadiene rubber (d₅₀ particle diameter=from 300 to 400 nm), produced by emulsion polymerization.

Component C:

SAN copolymer with 23% by weight acrylonitrile content and weight-average molar mass about 130 000 g/mol (determined by GPC in tetrahydrofuran, using polystyrene as standard).

Component D:

Bisphenol-A-Based Oligophosphate

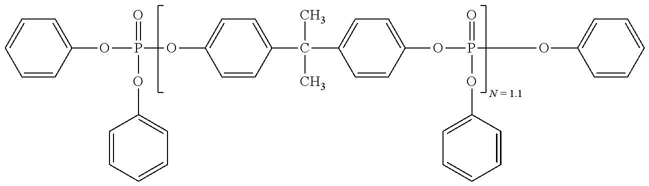

Component E:

HTP Ultra talc from Imi Fabi with 31.0% by weight MgO content, 61.5% by weight SiO₂ content and 0.4% by weight Al₂O₃ content, d₅₀ median particle size=0.5 μm.

Component F-1: Cycolac INP449: polytetrafluoroethylene (PTFE) preparation from Sabic composed of 50% by weight of PTFE present in an SAN copolymer matrix.

Component F-2: pentaerythritol tetrastearate

Component F-3: Irganox B 900 (producer: BASF).

Component F-4: Pural 200, AlO(OH) with boehmite structure (producer: Sasol Germany GmbH)

Component F-5: Black Pearls industrial carbon black (producer: Cabot Corporation)

Production and Testing of the Moulding Compositions of the Invention

The components were mixed in a ZSK-25 twin-screw extruder from Werner & Pfleiderer at a melt temperature of 260° C. The mouldings were produced at a melt temperature of 260° C. and a mould temperature of 80° C. in an Arburg 270 E injection-moulding machine.

MVR is determined in accordance with ISO 1133 (2012 version) at 240° C., using 5 kg ram loading. Table 1 indicates this value as “MVR value of ingoing sample”.

The change of MVR during storage of the granulate for 5 days at 95° C. and 100% relative humidity serves as measure of hydrolysis resistance.

Impact resistance (weld line strength) is determined on test specimens measuring 80 mm×10 mm×4 mm at 23° C. in accordance with ISO 179/1eU (2010 version).

Tensile strain at break is determined at room temperature in accordance with ISO 527 (1996 version).

Flame retardancy is assessed on strips measuring 127×12.7×1.5 mm in accordance with UL94V.

Resistance to environmental stress cracking (ESC) in toluene/isopropanol (60/40 parts by volume) at room temperature serves as measure of chemicals resistance. A test specimen measuring 80 mm×10 mm×4 mm injection-moulded at melt temperature 260° C. is subjected to 2.4% external outer fibre strain by means of a clamping template and completely immersed in the liquid, and the time required for fracture failure induced by environmental stress cracking is determined. The test method is based on ISO 22088 (2006 version).

TABLE 1
Moulding compositions and their properties

| | 1 | | | 4 | | 6 | | 8 |
|---|---|---|---|---|---|---|---|---|
| | Comp. | 2 | 3 | Comp. | 5 | Comp. | 7 | Comp. |
| Components | | | | | | | | |
| [parts by weight] | | | | | | | | |
| A-1 | 76.0 | 75.0 | 73.0 | 71.0 | — | — | — | — |
| A-2 | — | — | — | — | 75.0 | — | 73.0 | — |
| A-3 | — | — | — | — | — | 75.0 | — | 73.0 |
| B | 7.7 | 7.7 | 7.7 | 7.7 | 7.7 | 7.7 | 7.7 | 7.7 |
| C | 4.7 | 4.7 | 4.7 | 4.7 | 4.7 | 4.7 | 4.7 | 4.7 |
| D | 10.0 | 10.0 | 10.0 | 10.0 | 10.0 | 10.0 | 10.0 | 10.0 |
| E | — | 1.0 | 3.0 | 5.0 | 1.0 | 1.0 | 3.0 | 3.0 |
| F-1 | 0.8 | 0.8 | 0.8 | 0.8 | 0.8 | 0.8 | 0.8 | 0.8 |
| F-2 | 0.4 | 0.4 | 0.4 | 0.4 | 0.4 | 0.4 | 0.4 | 0.4 |
| F-3 | 0.1 | 0.1 | 0.1 | 0.1 | 0.1 | 0.1 | 0.1 | 0.1 |
| F-4 | 0.3 | 0.3 | 0.3 | 0.3 | 0.3 | 0.3 | 0.3 | 0.3 |
| F-5 | — | — | — | — | — | — | — | — |
| Properties | | | | | | | | |
| Weld line strength [kJ/m²] | 11 | 9 | 8 | 7 | 11 | 9 | 8 | 8 |
| Tensile strain at break [%] | 117 | 105 | 93 | 65 | 102 | 46 | 64 | 31 |
| Modulus of elasticity [MPa] | 2570 | 2700 | 2860 | 3140 | 2600 | 2600 | 2880 | 2800 |
| UL94V evaluation at 1.5 | V0 | V0 | V0 | V0 | V0 | V0 | V0 | V0 |
| mm | | | | | | | | |
| Total AFT [s] | 19 | 22 | 20 | 15 | 36 | 43 | 32 | 33 |
| (after 7 days of storage | | | | | | | | |
| at 70° C.) | | | | | | | | |
| ESC performance | 02:30 | 07:45 | 10:00 | 10:00 | 10:00 | 10:00 | 10:00 | 10:00 |
| [fracture after min:sec] | | | | | | | | |
| MVR of ingoing sample | 12 | 13 | 11 | 9 | 7 | 5 | 6 | 4 |
| [cm³/10 min] | | | | | | | | |
| MVR after storage (5 days) | 66 | 41 | 32 | 27 | 26 | 24 | 23 | 19 |
| [cm³/10 min] | | | | | | | | |
| Increase of MVR relative | 450 | 215 | 190 | 200 | 271 | 380 | 283 | 375 |
| to ingoing sample (in | | | | | | | | |
| %, storage for 5 days) | | | | | | | | |

n.m.: not measurable (viscosity of sample too low)

TABLE 2
Moulding compositions and their properties

| | 9 | | | 12 | 13 | | | 16 | 17 | 18 | 19 | 20 |
|---|---|---|---|---|---|---|---|---|---|---|---|---|
| | Comp. | 10 | 11 | Comp. | Comp. | 14 | 15 | Comp. | Comp. | Comp. | Comp. | Comp. |
| Components | | | | | | | | | | | | |
| [parts by weight] | | | | | | | | | | | | |
| A-1 | 93.3 | 92.3 | 90.3 | 88.3 | 72.3 | 71.3 | 69.3 | 67.3 | — | — | — | — |
| A-2 | — | — | — | — | — | — | — | — | 71.8 | — | 69.8 | — |
| A-3 | — | — | — | — | — | — | — | — | — | 71.8 | — | 69.8 |
| B | 3.0 | 3.0 | 3.0 | 3.0 | 9.0 | 9.0 | 9.0 | 9.0 | 9.0 | 9.0 | 9.0 | 9.0 |
| C | — | — | — | — | — | — | — | — | — | — | — | — |
| D | 2.3 | 2.3 | 2.3 | 2.3 | 17.0 | 17.0 | 17.0 | 17.0 | 17.0 | 17.0 | 17.0 | 17.0 |
| E | — | 1.0 | 3.0 | 5.0 | — | 1.0 | 3.0 | 5.0 | 1.0 | 1.0 | 3.0 | 3.0 |
| F-1 | 0.8 | 0.8 | 0.8 | 0.8 | 0.7 | 0.7 | 0.7 | 0.7 | 0.7 | 0.7 | 0.7 | 0.7 |
| F-2 | 0.5 | 0.5 | 0.5 | 0.5 | 0.4 | 0.4 | 0.4 | 0.4 | 0.4 | 0.4 | 0.4 | 0.4 |
| F-3 | 0.1 | 0.1 | 0.1 | 0.1 | 0.1 | 0.1 | 0.1 | 0.1 | 0.1 | 0.1 | 0.1 | 0.1 |
| F-4 | — | — | — | — | — | — | — | — | — | — | — | — |
| F-5 | — | — | — | — | 0.5 | 0.5 | 0.5 | 0.5 | — | — | — | — |
| Properties | | | | | | | | | | | | |
| Weld line strength [kJ/m²] | 121 | 33 | 15 | 11 | 26 | 13 | 8 | 6 | 19 | 16 | 11 | 10 |
| Tensile strain at break | 132 | 110 | 108 | 107 | 39 | 19 | 13 | 12 | 109 | 62 | 55 | 32 |
| [%] | | | | | | | | | | | | |
| Modulus of elasticity | 2360 | 2500 | 2750 | 2980 | 2560 | 2670 | 2400 | 3000 | 2620 | 2630 | 2890 | 2850 |
| [MPa] | | | | | | | | | | | | |
| UL94V evaluation at 1.5 | V0 | V0 | V0 | V0 | V0 | V0 | V0 | V0 | V0 | V0 | V0 | V0 |
| mm | | | | | | | | | | | | |
| Total AFT [s] | 15 | 10 | 10 | 11 | 11 | 11 | 19 | 10 | 11 | 12 | 10 | 10 |
| (after 7 days storage | | | | | | | | | | | | |
| at 70° C.) | | | | | | | | | | | | |
| ESC performance | 00:25 | 00:50 | 01:40 | 01:53 | 01:35 | 02:20 | 03:00 | 03:25 | 10:00 | 10:00 | 10:00 | 10:00 |
| [fracture after min:sec] | | | | | | | | | | | | |
| MVR of ingoing sample | 17 | 15 | 14 | 13 | 39 | 34 | 35 | 37 | 12 | 9 | 12 | 9 |
| [cm³/10 min] | | | | | | | | | | | | |
| MVR after storage (5 | 32 | 24 | 20 | 19 | n.m. | 123 | 100 | 89 | 56 | 54 | 47 | 41 |
| days) [cm³/10 min] | | | | | | | | | | | | |
| Increase of MVR relative | 88 | 60 | 42 | 46 | n.m. | 261 | 185 | 141 | 366 | 500 | 291 | 355 |
| to ingoing sample | | | | | | | | | | | | |
| (in %, storage for 5 days) | | | | | | | | | | | | |

n.m.: not measurable (viscosity of sample too low)

TABLE 3
Moulding compositions and their properties

| | 21 | | | 24 | 25 | | | 28 | | 30 |
|---|---|---|---|---|---|---|---|---|---|---|
| | Comp. | 22 | 23 | Comp. | Comp. | 26 | 27 | Comp. | 29 | Comp. |
| Components | | | | | | | | | | |
| [parts by weight] | | | | | | | | | | |
| A-1 | 75.1 | 74.1 | 72.1 | 70.1 | 72.6 | 71.6 | 69.6 | 67.6 | 73.45 | 73.45 |
| A-2 | — | — | — | — | — | — | — | — | — | — |
| A-3 | — | — | — | — | — | — | — | — | — | — |
| B | 7.9 | 7.9 | 7.9 | 7.9 | 9.0 | 9.0 | 9.0 | 9.0 | 6.6 | 5.7 |
| C | 1.6 | 1.6 | 1.6 | 1.6 | 4.7 | 4.7 | 4.7 | 4.7 | 5.1 | 6.0 |
| D | 14.0 | 14.0 | 14.0 | 14.0 | 12.5 | 12.5 | 12.5 | 12.5 | 12.5 | 12.5 |
| E | — | 1.0 | 3.0 | 5.0 | — | 1.0 | 3.0 | 5.0 | 1.0 | 1.0 |
| F-1 | 1.0 | 1.0 | 1.0 | 1.0 | 0.8 | 0.8 | 0.8 | 0.8 | 0.8 | 0.8 |
| F-2 | 0.4 | 0.4 | 0.4 | 0.4 | 0.4 | 0.4 | 0.4 | 0.4 | 0.4 | 0.4 |
| F-3 | 0.1 | 0.1 | 0.1 | 0.1 | 0.1 | 0.1 | 0.1 | 0.1 | 0.1 | 0.1 |
| F-4 | — | — | — | — | — | — | — | — | — | — |
| F-5 | — | — | — | — | — | — | — | — | — | — |
| Properties | | | | | | | | | | |
| Weld line strength [kJ/m²] | 12 | 11 | 8 | 6 | 9 | 8 | 7 | 5 | 9 | 8 |
| Tensile strain at break [%] | 120 | 100 | 86 | 74 | 71 | 120 | 80 | 52 | 110 | 99 |
| Modulus of elasticity [MPa] | 2680 | 2770 | 3080 | 3100 | 2500 | 2620 | 2840 | 3000 | 2730 | 2800 |
| UL94V evaluation at 1.5 | V0 | V0 | V0 | V0 | V0 | V0 | V0 | V0 | V0 | V0 |
| mm | | | | | | | | | | |
| Total AFT [s] | 10 | 12 | 10 | 11 | 13 | 14 | 16 | 13 | 15 | 18 |
| (after 7 days of storage | | | | | | | | | | |
| at 70° C.) | | | | | | | | | | |
| ESC performance | 02:00 | 02:10 | 10:00 | 10:00 | 03:30 | 04:32 | 10:00 | 10:00 | 10:00 | 10:00 |
| [fracture after min:sec] | | | | | | | | | | |
| MVR of ingoing sample | 17 | 17 | 16 | 15 | 19 | 18 | 18 | 16 | 18 | 21 |
| [cm³/10 min] | | | | | | | | | | |
| MVR after storage (5 days) | n.m. | 65 | 46 | 39 | n.m. | 69 | 45 | 48 | 59 | 62 |
| [cm³/10 min] | | | | | | | | | | |
| Increase of MVR relative | n.m. | 282 | 176 | 160 | n.m. | 283 | 150 | 200 | 227 | 195 |
| to ingoing sample (in | | | | | | | | | | |
| %, storage for 5 days) | | | | | | | | | | |

n.m.: not measurable (viscosity of sample too low)

The examples of Table 1 show that a good combination of high tensile strain at break, good weld line strength, high chemicals resistance and good hydrolysis resistance is achieved only with the compositions comprising the talc content of the invention. If no talc is used, hydrolysis resistance is inadequate. If an excessive talc content is used, weld line strength and tensile strain at break deteriorate unacceptably.

1. A composition comprising:
A) from 62 to 96% by weight of at least one polymer selected from the group consisting of linear aromatic polycarbonate and linear aromatic polyester carbonate,
B) from 1 to 15% by weight of at least one graft polymer produced by emulsion polymerization from
B.1) from 5 to 95% by weight, based on B, of a mixture of
B.1.1) from 50 to 99% by weight, based on B.1, of at least one monomer selected from the group of the vinylaromatics, ring-substituted vinylaromatics and C1-C8-alkyl acrylates and mixtures of these compounds
and
B.1.2) from 1 to 50% by weight, based on B.1, of at least one monomer selected from the group of the vinyl cyanides, C1-C8-alkyl acrylates, unsaturated carboxylic acids and derivatives of unsaturated carboxylic acids
B.2) from 5 to 95% by weight, based on B, of a rubber-containing graft base comprising a diene rubber or comprising a copolymer of a diene rubber with another copolymerizable monomer,
C) from 0 to 5.8% by weight of rubber-free vinyl (co)polymer,
D) from 1 to 20% by weight of at least one phosphorus-containing flame retardant of the general formula (IV) 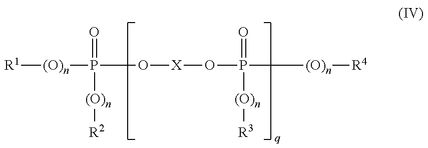
wherein:
R1, R2, R3 and R4, mutually independently respectively denote at least one of C1 to C8-alkyl, C5 to C6-cycloalkyl, C6 to C20-aryl and C7 to C12-aralkyl,
n mutually independently denotes 0 or 1
q denotes integral values from 1 to 30
X denotes a polynuclear aromatic moiety having from 13 to 30 C atoms,
E) from 0.8 to 4.0% by weight of a mineral filler based on talc with d₅₀ particle size from 0.2 to 10 μm,
F) from 0.1 to 20.0% by weight of at least one polymer additive,
where the compositions comprise no graft polymer produced by bulk polymerization.

2. The composition according to claim 1 comprising
from 64 to 95% by weight of component A,
from 2 to 12% by weight of component B,
from 0 to 5.5% by weight of component C,
from 1 to 19% by weight of component D,
from 0.9 to 3.5% by weight of component E; and
from 0.2 to 15% by weight of component F.

3. The composition according to claim 1 comprising
from 66 to 94% by weight of component A,
from 3 to 10% by weight of component B,
from 0 to 5.2% by weight of component C,
from 2 to 18% by weight of component D,
from 1.0 to 3.0% by weight of component E; and
from 0.3 to 10% by weight of component F.

4. The composition according to claim 1, wherein the weight-average molar mass, Mw, of component A is from 24000 to 28000 g/mol.

5. The composition according to claim 1, wherein component B comprises from 40 to 70% by weight of B.1 and from 60 to 30% by weight of B.2, based in each case on B.

6. The composition according to claim 1, wherein component B1.1 comprises styrene and component B1.2 comprises acrylonitrile.

7. The composition according to claim 1, wherein component D is a compound according to the following structure:

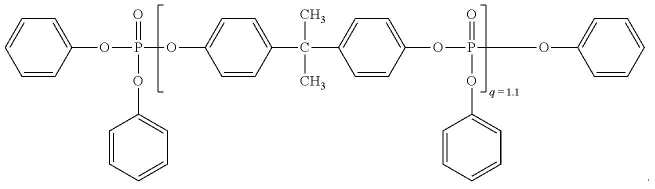

8. The composition according to claim 1, wherein component E is talc with from 28 to 35% by weight MgO content, from 55 to 65% by weight SiO₂ content and less than 1% by weight Al₂O₃ content.

9. The composition according to claim 1, wherein the d₅₀ particle size of component E is from 0.7 to 2.5 μm.

10. The composition according to claim 1, wherein the MgO content of component E is from 30.5 to 32% by weight.

11. The composition according to claim 1, wherein component F comprises one or more additives selected from the group consisting of flame retardant synergists, antidripping agent, lubricant and mould-release agent, flowability aid, antistatic agents, conductivity additives, stabilizers, antibacterial additives, additives that improve scratch resistance, IR absorbers, optical brightener, fluorescent additives, dyes, pigments and Brönstedt acid compounds.

12. The composition according to claim 1, wherein the composition consists of the components A to F.

13. A method comprising adding talc with d₅₀ particle size from 0.7 to 2.5 μm and from 28 to 35% by weight MgO content to a polycarbonate composition comprising a graft polymer produced by an emulsion process and bisphenol A oligophosphate as flame retardant to improve the hydrolysis resistance of the polycarbonate composition.

14. A method for producing mouldings comprising the composition according to claim 1.

15. A moulding produced from the composition according to claim 1.

16. The composition of claim 1, wherein at least one of R1, R2, R3 and R4 comprises at least one of a substituent halogen group and a substituent alkyl group.
